(19) United States
(12) Patent Application Publication
(10) Pub. No.: US 2019/0348847 A1
(43) Pub. Date: Nov. 14, 2019

(54) ELECTRONIC APPARATUS, CHARGING PLATFORM AND CHARGING SYSTEM

(71) Applicant: SHARP KABUSHIKI KAISHA, Osaka (JP)

(72) Inventor: SHOGO SAKAI, Sakai City (JP)

(21) Appl. No.: 16/393,430

(22) Filed: Apr. 24, 2019

(30) Foreign Application Priority Data
May 10, 2018 (JP) 2018-091652

(51) Int. Cl. H02J 7/00; B25J 19/00

(52) U.S. Cl. CPC H02J 7/0044; B25J 19/005; H02J 7/0068

(57) ABSTRACT

An aspect of the present invention causes a movable part of an electronic device to operate so that the movable part of the electronic apparatus moves, while keeping the electronic apparatus being charged. A robot includes a fit portion which is fitted with a fitting portion of a charging platform. The charging platform includes a backrest part which causes the movable part of the electronic apparatus to operate so that the movable part of the electronic apparatus moves, in a state in which a power supply connector of the charging platform and a power receiving connector of the robot are connected to each other and the fitting portion of the charging platform and the fit portion of the robot are fitted together.

This Nonprovisional application claims priority under 35 U.S.C. § 119 on Patent Application No. 2018-091652 filed in Japan on May 10, 2018, the entire contents of which are hereby incorporated by reference.

### TECHNICAL FIELD

The present invention relates to an electronic apparatus, a charging platform, and a charging system including the electronic apparatus and the charging platform.

### BACKGROUND ART

Patent Literature 1 discloses, as a charging system for charging a battery provided in a robot which is an electronic apparatus, a charging system for charging a battery provided in a legged locomotion robot by connecting an external power source to the legged locomotion robot.

The charging system includes a charging device 101 having a chair-like shape, a seated posture maintaining section 102, a power supply connector 103, and a charging unit 104, as shown in (a) of FIG. 4. The seated posture maintaining section 102 holds back sides of an upper body part 113 and thigh parts 114 of a bipedal walking robot 110 when the bipedal walking robot 110 is seated, and keeps the bipedal walking robot 110 in a seated posture. The power supply connector 103 mates with a power receiving connector 112 provided on the bipedal walking robot 110. The charging unit 104 supplies electric current to the bipedal walking robot 110 via the power supply connector 103 and the power receiving connector 112.

Patent Literature 1 also discloses an embodiment as shown in the (b) of FIG. 4. In this embodiment, a posture maintaining section 102a is provided in a charging device 101a. The posture maintaining section 102a is a portion for allowing the bipedal walking robot 110 to have a half-sitting posture and lean on the charging device 101a. The power receiving connector 112 of the bipedal walking robot 110 and the power supply connector 103 of the charging device 101a are connected to each other while the bipedal walking robot 110 having the half-sitting posture is leaning on the posture maintaining section 102a.

Patent Literature 1 also discloses an embodiment as shown in (c) of the FIG. 4. In this embodiment, a posture maintaining section 102b is provided in a charging device 101b. The posture maintaining section 102b is a portion for allowing the bipedal walking robot 110 to have a standing posture and lean on the charging device 101b. The charge connector 112 of the bipedal walking robot 110 and the power supply connector 103 of the charging device 101b are connected to each other while the bipedal walking robot 110 having the standing posture is leaning on the posture maintaining section 102b.

### CITATION LIST

### Patent Literature

[Patent Literature 1] Japanese Patent Application Publication, Tokukai, No. 2006-68846 (Publication date: Mar. 16, 2006)

### SUMMARY OF INVENTION

### Technical Problem

However, in the above conventional technique, the bipedal walking robot 110 is charged while the power receiving connector 112 of the bipedal walking robot 110 is mated with the power supply connector 103 of the charging device. During such charging of the bipedal walking robot 110, a position of the power receiving connector 112 cannot be moved. Therefore, there has been a problem that movement of the bipedal walking robot 110 is limited.

An aspect of the present invention has been attained in view of the above-mentioned problem. An object of an aspect of the present invention is to provide a charging platform or the like which can cause a movable part of an electronic apparatus to operate so that the movable part moves, while the electronic apparatus is being charged.

### Solution to Problem

In order to solve the above problem, a charging system according to an aspect of the present invention is configured to be a charging system including: a charging platform including: a power supply connector connected to an external power source; a fitting portion; and a movable member; and an electronic apparatus including: a power receiving connector connected to a battery; a fit portion fitting with the fitting portion of the charging platform; and a movable part, the movable member of the charging platform causing the movable part of the electronic apparatus to operate so that the movable part of the electronic apparatus moves, in a state in which the power supply connector of the charging platform and the power receiving connector of the electronic apparatus are connected to each other and the fitting portion of the charging platform and the fit portion of the electronic apparatus are fitted together, and the battery being charged when the external power source and the battery are electrically connected to each other.

In order to solve the above problem, a charging system according to an aspect of the present invention is configured to be an electronic apparatus to be placed on a charging platform which includes a power supply connector connected to an external power source, the electronic apparatus including: a power receiving connector connected to a battery and to the power supply connector; a fit portion fitting with a fitting portion of the charging platform; and a movable part operating so as to move, in a state in which the power receiving connector of the electronic apparatus is connected to the power supply connector of the charging platform and the fit portion of the electronic apparatus is fitted with the fitting portion of the charging platform.

In order to solve the above problem, a charging system according to an aspect of the present invention is configured to be a charging platform on which an electronic apparatus is to be placed, the electronic apparatus including a power receiving connector connected to a battery and also including a movable part, the charging platform including: a power supply connector connected to an external power source; a fitting portion to be fitted with a fit portion of the electronic apparatus; and a movable member which causes a movable part of the electronic apparatus to operate so that the movable part of the electronic apparatus moves, in a state in which the power supply connector of the charging platform is connected with the power receiving connector of the electronic apparatus' and the fitting portion of the charging platform is fitted with the fit portion of the electronic apparatus.

### Advantageous Effects of Invention

According to an aspect of the present invention, it is possible to cause a movable part of an electronic apparatus so that the movable part moves, while the electronic apparatus is being charged.

### BRIEF DESCRIPTION OF DRAWINGS

FIG. 1 is a diagram illustrating an overview of a structure and an operation of a charging system according to Embodiment 1 of the present invention.

FIG. 2 is a diagram illustrating an overview of a structure and an operation of a charging system according to Embodiment 2 of the present invention.

FIG. 3 is a diagram illustrating an overview of a structure and an operation of a charging system according to Embodiment 3 of the present invention.

FIG. 4 is a diagram illustrating an example configuration of a conventional charging system.

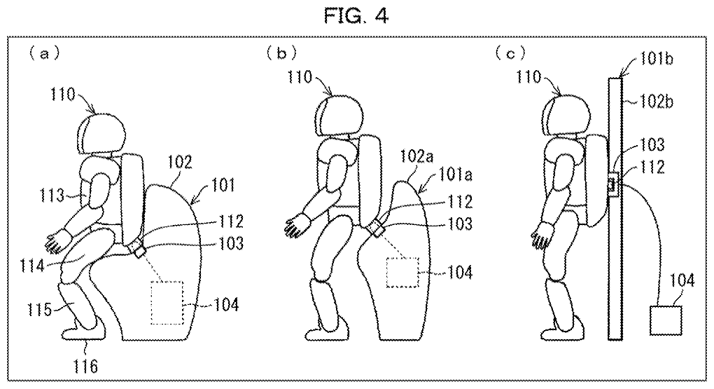

### DESCRIPTION OF EMBODIMENTS

### Embodiment 1

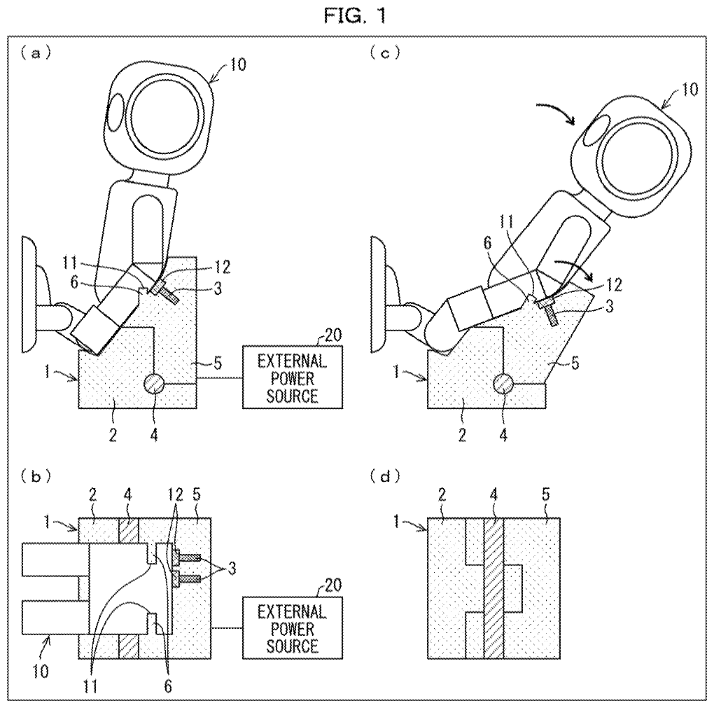

The following will discuss in detail a charging system according to Embodiment 1 of the present invention. As shown in (a) of FIG. 1, the charging system includes a charging platform 1, a robot (electronic apparatus) 10 and an external power source 20. The charging system electrically connects the external power source 20 and a battery (not shown) built in the robot 10, and charges the battery. (b) of FIG. 1 is a transverse cross-sectional view of the charging system shown in (a) of FIG. 1.

In Embodiment 1, the robot 10 will be described as an example of the electronic apparatus placed on the charging platform 1. The electronic apparatus placed on the charging platform 1 is not limited to a robot. The electronic apparatus can be any electronic apparatus having a predetermined movable part which operates so as to move in conjunction with a movement of a backrest part 5 of the charging platform 1 in an operation of the backrest part 5. The robot 10 of Embodiment 1 is assumed to have a movable part (not shown) which operates so as to move in conjunction with the backrest part 5 of the charging platform 1. The predetermined movable part is, for example, a joint connecting an upper body part and a thigh part of the robot 10.

The robot 10 of Embodiment 1 has a humanoid shape, and has a power receiving connector 12 which is connected to the battery described above. The robot 10 also includes a fit portion 11 into which a fitting portion 6 provided on the backrest part 5 (or the charging platform 1) described later fits.

The charging platform 1 of Embodiment 1 has a chair-like shape. The charging platform 1 includes a seat part 2 which is fixed to a floor, and a backrest part (movable member) 5 which operates so as to move in a circular manner about a shaft 4. The charging platform 1 is a platform which supports the robot 10 when the robot 10 is charged. The seat part 2 supports the backrest part 5 via the shaft 4. The backrest part 5 supports the back of the robot 10 when the robot 10 is seated (placed) on the charging platform 1.

The backrest part 5 of the charging platform 1 is configured to operate so as to move in a rotational manner about the shaft 4, relative to the seat part. This allows the movable part to be operated so that the movable part of the robot 10 moves, while the robot is kept seated (placed) on the seat part 2.

The seat part 2 and the backrest part 5 are connected to each other by insertion of the shaft 4 into a hole which is formed in the seat part 2 and a hole which is formed in the backrest part 5, as in the charging platform 1 shown in a transverse cross-sectional view of (d) of FIG. 1. That is, the seat part 2 and the backrest part 5 are connected to each other by insertion of the shaft 4 into the holes which penetrate the seat part 2 and the backrest part 5, respectively. The seat part 2 can have a box-like shape as in Embodiment 1, but can alternatively have a chair leg-like shape so that the charging platform 1 has a shape like a general chair.

The backrest part 5 includes a power supply connector 3 which is connected with the external power source 20, and the fitting portion 6 which fits in the fit portion 11 of the robot 10. More specifically, the backrest part 5 is provided with a projection (the fitting portion 6) which is inserted into the fit portion 11 of the robot 10. With this structure, the backrest part 5 does not detach from the backrest part 5 unless the robot 10 is moved along a direction in which the robot 10 is inserted.

Further, at the same time as the fitting portion 6 of the backrest part 5 is fitted into the fit portion 11 of the robot 10 and the robot 10 is inserted into the charging platform 1, the power receiving connector 12 of the robot 10 and the power supply connector 3 of the backrest part 5 mate with each other.

As described above, the backrest part 5 is configured to operate so as to move in a rotational manner about the shaft 4, relative to the seat part 2. For example, (a) of FIG. 1 shows a state prior to operating the movable part of the robot 10. (c) of FIG. 1 shows a state in which the movable part of the robot 10 is operated so as to move, by causing the backrest part 5 to operate so that the backrest part 5 moves, relative to the seat part 2, clockwise about the shaft 4 on a paper surface of (c) of FIG. 1.

The backrest part 5 causes the movable part of the robot 10 to operate so that the movable part moves, in a state in which the power receiving connector 12 and the power supply connector 3 are connected to each other and the fitting portion 6 is fitted in the fit portion 11. Therefore, even when the robot 10 operates so as to move, a positional relation between the robot 10 and the backrest part 5 is maintained. Therefore, the robot 10 can operate so as to move, while the robot is kept being charged.

When the robot 10 is seated on the charging platform 1, the fitting portion 6 of the backrest part 5 fits into the fit portion 11 of the robot 10. Then, the robot 10 is fixed to the charging platform 1. Further, at the same time as the fitting portion 6 of the backrest part 5 fits into the fit portion 11 of the robot 10, the power supply connector 3 of the backrest part 5 is electrically connected to the power receiving connector 12 of the robot 10. More specifically, the power receiving connector 12 of the robot 10 is electrically connected to the power supply connector 3 of the backrest part 5, when the power receiving connector 12 mates with the power supply connector 3. This electrically connects, with the external power source 20, the battery which is built in the robot 10, so that the battery is charged.

When the movable part of the robot 10 operates so as to move, the backrest part 5 moves, away from the seat part 2, in a rotational manner about the shaft 4. Even when the robot 10 and the backrest part 5 operate so as to move, the positional relation between the robot 10 and the backrest part 5 is maintained. As a result, while the robot 10 is kept being charged, it is possible to keep a range in which the robot 10 moves wide.

That is, the above configuration allows the external power source 20 and the battery to be electrically connected to each other when the power receiving connector 12 and the power supply connector 3 are connected to each other. In addition, the above-described configuration allows the robot 10 to be fixed to the charging platform 1 by fitting the fitting portion 6 of the charging platform 1 into the fit portion 11 of the robot 10.

Further, in the above configuration, the backrest part 5 of the charging platform 1 causes the movable part to operate so that the movable part 10 moves, in a state in which the power receiving connector 12 and the power supply connector 3 are connected to each other and the fitting portion 6 is fitted in the fit portion 11. Therefore, the movable part of the robot 10 can be operated so as to move, while the robot 10 is kept being charged.

The robot 10 is placed on the charging platform 1 which has the power supply connector 3 connected to the external power source 20. Moreover, the robot 10 includes: the power receiving connector 12 which is connected to the battery and also connected to the power supply connector 3; the fit portion 11 which mates with the fitting portion 6 of the charging platform 1; and the movable part which operates so as to move, in a state in which the power receiving connector 12 is connected to the power supply connector 3 of the charging platform 1 and the fit portion 11 is fitted with the fitting portion 6 of the charging platform 1.

Meanwhile, the charging platform 1 is a platform which has the power supply connector 3 connected to the external power source 20, and on which the robot 10 is placed. This robot 10 has the movable part and the power receiving connector 12 which is connected to the battery. The charging platform 1 includes: the fitting portion 6 which is fitted into the fit portion 11 of the robot 10; and the backrest part 5 which causes the movable part of the robot 10 to operate so that the movable part moves, in a state in which the power supply connector 3 of the charging platform 1 is connected to the power receiving connector 12 of the robot 10 and the fitting portion 6 of the charging platform 1 is fitted in the fit portion 11 of the robot 10. With this configuration, when the robot 10 is placed on the charging platform 1, the movable part of the robot 10 can be operated so as to move, while the robot 1 is kept being charged.

### Embodiment 2

Another embodiment of present invention is described below. For convenience of description, members having functions identical to those of Embodiment 1 are assigned identical referential numerals and their descriptions are omitted.

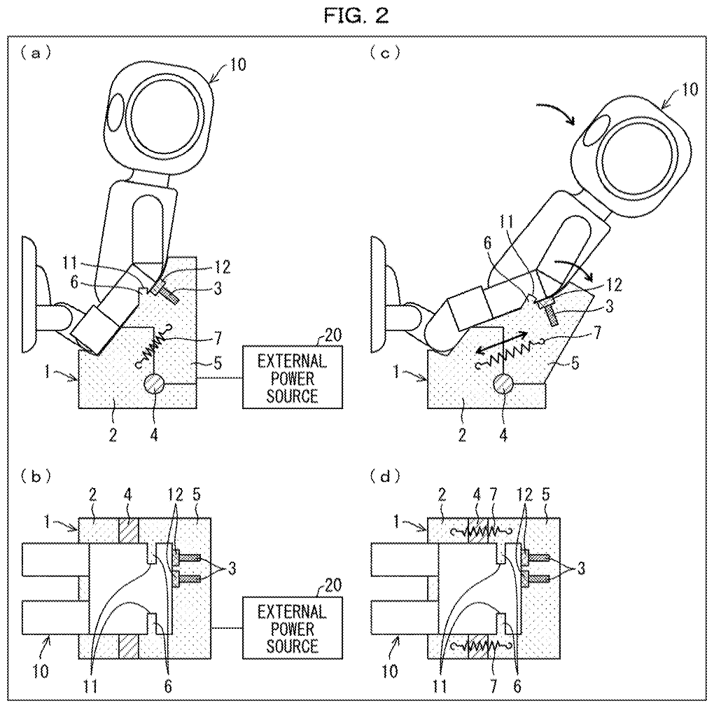

A charging system of Embodiment 2 differs from the charging system of Embodiment 1 in that, as shown in (a) of FIG. 2, a spring (elastic body) 7 which expands and contracts is provided between a seat part 2 and a backrest part 5 so as to connect the seat part 2 and the backrest part 5 to each other. The spring 7 has hooks at both ends, and the spring 7 is attached such that the hooks are caught by projections which are formed on the seat part 2 and the backrest part 5, respectively.

(d) of FIG. 2 is a transverse cross-sectional view illustrating the charging system shown in (a) of FIG. 2. (b) of FIG. 2 is a transverse cross-sectional view illustrating the charging system prior to attachment of the spring 7 to the charging system.

In the charging system of Embodiment 2, the charging platform 1 includes the spring 7, which exerts a force on the seat part 2 and the backrest part 5 in a direction opposite to a direction in which the robot 10 moves when a movable part of the robot 10 is operated by the backrest part 5 so as to move. The force in the direction opposite to the direction in which the robot 10 moves acts as a force for maintaining a posture of the robot 10. As a result, the posture of the robot 10 is not easily lost by slight vibration or external force, so that the posture of the robot 10 is easily maintained.

Also in Embodiment 2, the backrest part 5 is configured to operate so as to move in a rotational manner about a shaft 4, relative to the seat part 2. For example, (a) of FIG. 2 shows a state prior to operating the movable part of the robot 10. (c) of FIG. 2 shows a state in which the movable part of the robot 10 is operated so as to move, by causing the backrest part 5 to operate so that the backrest part 5 moves, relative to the seat part 2, clockwise about the shaft 4 on a paper surface of (c) of FIG. 2.

At this time, since the backrest part 5 moves, away from the seat part 2, in a rotational manner about the shaft 4, the spring 7 connecting the seat part 2 and the backrest part 5 to each other expands. Then, a contracting force of the spring 7 acts in a direction opposite to a direction in which the backrest part 5 moves.

Since the contracting force of the spring 7 acts moderately in the direction opposite to the direction in which the backrest part 5 moves, the contracting force of the spring 7 functions as a force for maintaining a posture of the robot 10 after the robot 10 is moved. As a result, the posture of the robot 10 is not easily lost by slight vibration or external force, so that the posture of the robot 10 is easily maintained. Even when the robot 10 and the backrest part 5 operate so as to move, a positional relation between the robot 10 and the backrest part 5 is maintained. As a result, while the robot 10 is kept being charged, it is possible to keep a range in which the robot 10 moves wide.

### Embodiment 3

Another embodiment of present invention is described below. For convenience of description, members having functions identical to those of Embodiments 1 and 2 are assigned identical referential numerals and their descriptions are omitted.

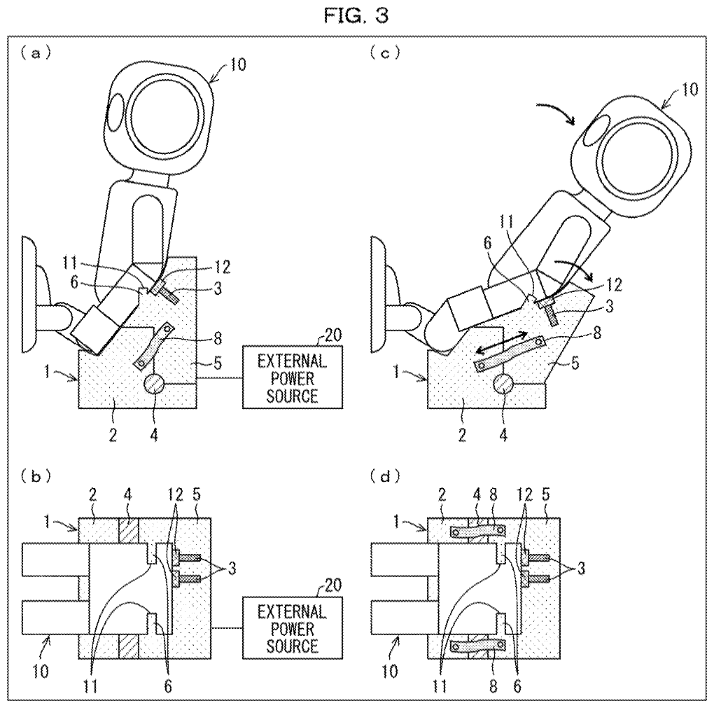

A charging system of Embodiment 3 differs from the charging systems of Embodiments 1 and 2 in that, as shown in (a) of FIG. 3, a rubber (elastic body) 8 which expands and contracts is provided between a seat part 2 and a backrest part 5 so as to connect the seat part 2 and the backrest part to each other. The rubber 8 has holes at both end portions, and the rubber 8 is attached such that the holes are caught by projections which are formed on the seat part 2 and the backrest part 5, respectively.

(d) of FIG. 3 is a transverse cross-sectional view illustrating the charging system shown in (a) of FIG. 3. (b) of FIG. 3 is a transverse cross-sectional view illustrating the charging system prior to attachment of the rubber 8 to the charging system.

In the charging system of Embodiment 3, the charging platform 1 includes the rubber 8, which exerts a force on the seat part 2 and the backrest part 5 in a direction opposite to a direction in which the robot 10 moves when a movable part of the robot 10 is operated by the backrest part 5 so as to move. The force in the direction opposite to the direction in which the robot 10 moves acts as a force for maintaining a posture of the robot 10. As a result, the posture of the robot 10 is not easily lost by slight vibration or external force, so that the posture of the robot 10 is easily maintained.

Also in Embodiment 3, the backrest part 5 is configured to operate so as to move in a rotational manner about a shaft 4, relative to the seat part 2. For example, (a) of FIG. 3 shows a state prior to operating the movable part of the robot 10. (c) of FIG. 3 shows a state in which the movable part of the robot 10 is operated so as to move, by causing the backrest part 5 to operate so that the backrest part 5 moves, relative to the seat part 2, clockwise about the shaft 4 on a paper surface of (c) of FIG. 3.

At this time, since the backrest part 5 moves away from the seat part 2, in a rotational manner about the shaft 4, the rubber 8 connecting the seat part 2 and the backrest part 5 to each other expands. Then, a contracting force of the rubber 8 acts in a direction opposite to a direction in which the backrest part 5 moves.

Since the contracting force of the rubber 8 acts moderately in the direction opposite to the direction in which the backrest part 5 moves, the contracting force of the rubber 8 functions as a force for maintaining a posture of the robot 10 after the robot 10 is moved. As a result, the posture of the robot 10 is not easily lost by slight vibration or external force, so that the posture of the robot 10 is easily maintained. Even when the robot 10 and the backrest part 5 operate so as to move, a positional relation between the robot 10 and the backrest part 5 is maintained. As a result, while the robot 10 is kept being charged, it is possible to keep a range in which the robot 10 moves wide.

[Recap]

A charging system according to Aspect 1 of present invention is a charging system including a charging platform (1) including: a power supply connector (3) connected to an external power source (20); a fitting portion (6); and a movable member; and an electronic apparatus (robot 10) including: a power receiving connector (12) connected to a battery; a fit portion (11) fitting with the fitting portion of the charging platform; and a movable part, the movable member of the charging platform causing the movable part of the electronic apparatus to operate so that the movable part of the electronic apparatus moves, in a state in which the power supply connector of the charging platform and the power receiving connector of the electronic apparatus are connected to each other and the fitting portion of the charging platform and the fit portion of the electronic apparatus are fitted together, and the battery being charged when the external power source and the battery are electrically connected to each other.

In the above configuration, the external power source and the battery are electrically connected to each other by connecting the power receiving connector and the power supply connector to each other. Further, in the above configuration, the electronic apparatus can be fixed to the charging platform by fitting the fitting portion of the charging platform into the fit portion of the electronic apparatus.

Furthermore, in the above configuration, the movable member of the charging platform causes the movable part of the electronic apparatus to operate so that the movable part of the electronic apparatus moves, in a state in which the power supply connector of the charging platform and the power receiving connector of the electronic apparatus are connected to each other and the fitting portion of the charging platform and the fit portion of the electronic apparatus are fitted together. Therefore, the movable part of the electronic apparatus can be caused to operate so that the movable part of the electronic apparatus moves, while the electronic apparatus is kept being charged. Note that the movable part of the electronic apparatus is assumed to operate so that the movable part of the electronic apparatus moves in conjunction with the movable member of the charging platform.

A charging system according to Aspect 2 of present invention can be configured such that in the above Aspect 1, the charging platform further includes a seat part (2) on which the electronic apparatus is placed; and the movable part of the electronic apparatus operates so as to move relative to the seat part of the charging platform. This configuration makes it possible to cause the electronic apparatus to operate so that the electronic apparatus moves, in a state in which the electronic apparatus is placed on the seat part.

A charging system according to Aspect 3 of present invention is preferably configured such that in the above Aspect 2, the charging platform further includes an elastic body (spring 7, rubber 8) which exerts, on the seat part and the movable member, a force in a direction opposite to a direction in which the electronic apparatus moves, in a case where the movable member of the charging platform causes the movable part of the electronic apparatus to operate so that the movable part of the electronic apparatus moves. In this configuration, the force in the direction opposite to the direction in which the electronic apparatus moves acts as a force for maintaining a posture of the electronic apparatus. As a result, the posture of the electronic apparatus is not easily lost by slight vibration or external force, so that the posture of the electronic apparatus is easily maintained.

A charging system according to Aspect 4 of present invention can be configured such that in the above Aspect 3, the elastic body is a spring.

A charging system according to Aspect 5 of present invention is preferably configured such that in the above Aspect 3, the elastic body is a rubber.

An electronic apparatus according to Aspect 6 of the present invention is configured to be an electronic apparatus to be placed on a charging platform which includes a power supply connector connected to an external power source, the electronic apparatus including: a power receiving connector connected to a battery and to the power supply connector; a fit portion fitting with a fitting portion of the charging platform; and a movable part operating so as to move, in a state in which the power receiving connector of the electronic apparatus is connected to the power supply connector of the charging platform and the fit portion of the electronic apparatus is fitted with the fitting portion of the charging platform. With this configuration, it is possible to cause the movable part of the electronic apparatus placed on the charging platform to operate so that the movable part of the electronic apparatus moves, while the electronic device is kept being charged.

A charging platform according to Aspect 7 of the present invention is configured to be a charging platform on which an electronic apparatus is to be placed, the electronic apparatus including a power receiving connector connected to a battery and also including a movable part, the charging platform including: a power supply connector connected to an external power source; a fitting portion to be fitted with a fit portion of the electronic apparatus; and a movable member which causes a movable part of the electronic apparatus to operate so that the movable part of the electronic apparatus moves, in a state in which the power supply connector of the charging platform is connected with the power receiving connector of the electronic apparatus and the fitting portion of the charging platform is fitted with the fit portion of the electronic apparatus. With this configuration, it is possible to cause the movable part of the electronic apparatus placed on the charging platform to operate so that the movable part of the electronic apparatus moves, while the electronic device is kept being charged.

[Additional Remarks]

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

1 Charging platform
2 Seat part
3 Power supply connector
4 Shaft
5 Backrest part (movable member)
6 Fitting portion
7 Spring (elastic body)
8 Rubber (elastic body)
10 Robot (electronic apparatus)
11 Fit portion
12 Power receiving connector
20 External power source

1. A charging system comprising:
a charging platform including:
a power supply connector connected to an external power source;
a fitting portion; and
a movable member; and
an electronic apparatus including:
a power receiving connector connected to a battery;
a fit portion fitting with the fitting portion of the charging platform; and
a movable part,
the movable member of the charging platform causing the movable part of the electronic apparatus to operate so that the movable part of the electronic apparatus moves, in a state in which the power supply connector of the charging platform and the power receiving connector of the electronic apparatus are connected to each other and the fitting portion of the charging platform and the fit portion of the electronic apparatus are fitted together, and
the battery being charged when the external power source and the battery are electrically connected to each other.

2. The charging system as set forth in claim 1, wherein:
the charging platform further includes a seat part on which the electronic apparatus is placed; and
the movable part of the electronic apparatus operates so as to move relative to the seat part of the charging platform.

3. The charging system as set forth in claim 2, wherein:
the charging platform further includes an elastic body which exerts, on the seat part and the movable member, a force in a direction opposite to a direction in which the electronic apparatus moves, in a case where the movable member of the charging platform causes the movable part of the electronic apparatus to operate so that the movable part of the electronic apparatus moves.

4. The charging system as set forth in claim 3, wherein:
the elastic body is a spring.

5. The charging system as set forth in claim 3, wherein:
the elastic body is a rubber.

6. An electronic apparatus to be placed on a charging platform which includes a power supply connector connected to an external power source, the electronic apparatus comprising:
a power receiving connector connected to a battery and to the power supply connector;
a fit portion fitting with a fitting portion of the charging platform; and
a movable part operating so as to move, in a state in which the power receiving connector of the electronic apparatus is connected to the power supply connector of the charging platform and the fit portion of the electronic apparatus is fitted with the fitting portion of the charging platform.

7. A charging platform on which an electronic apparatus is to be placed, the electronic apparatus including a power receiving connector connected to a battery and also including a movable part,
the charging platform comprising:
a power supply connector connected to an external power source;
a fitting portion to be fitted with a fit portion of the electronic apparatus; and
a movable member which causes a movable part of the electronic apparatus to operate so that the movable part of the electronic apparatus moves, in a state in which the power supply connector of the charging platform is connected with the power receiving connector of the electronic apparatus and the fitting portion of the charging platform is fitted with the fit portion of the electronic apparatus.
